(19) United States
(12) Patent Application Publication
(10) Pub. No.: US 2024/0227805 A1
(43) Pub. Date: Jul. 11, 2024

(54) METHOD FOR CONTROLLING A SPEED OF A VEHICLE, CONTROL UNIT, COMPUTER PROGRAM PRODUCT, NON-TRANSITORY COMPUTER READABLE STORAGE MEDIUM, BRAKE SYSTEM, AND VEHICLE

(71) Applicant: Volvo Construction Equipment AB, Eskilstuna (SE)

(72) Inventors: Björn Dusemund, Trier (DE); Krishnent Sanal Kumar, Trier (DE); Tim Weidke, Hilscheid (DE)

(21) Appl. No.: 18/528,918

(22) Filed: Dec. 5, 2023

(30) Foreign Application Priority Data
Jan. 6, 2023 (EP) 23150550.4

(51) Int. Cl. B60W 30/18; B60W 10/08; B60W 10/188

(52) U.S. Cl. CPC B60W 30/18009; B60W 10/08; B60W 10/188; B60W 2300/17; B60W 2520/105; B60W 2520/16; B60W 2540/12; B60W 2720/10

(57) ABSTRACT

A method includes: determining an actual speed value of a vehicle, determining a maximum speed value, and determining a critical speed value larger than the maximum speed value, and determining the actual driving condition of the vehicle, determining a target speed value of the vehicle that is smaller than the determined maximum speed value, and wherein if the driving condition is determined as the over speed driving condition, determining a speed braking signal value for actuating the friction braking unit depending on the determined target speed value, and providing the speed braking signal value to the brake system for actuating the friction braking unit.

### CROSS REFERENCE TO RELATED APPLICATION

This application claims priority to European Patent Application Number 23150550.4, filed on Jan. 6, 2023, the disclosure and content of which is incorporated by reference herein in its entirety.

### TECHNICAL FIELD

The disclosure relates to a method and a control unit for controlling a speed of a vehicle depending on a determined actual driving condition of the vehicle. Further, the disclosure relates to a computer program product, a non-transitory computer-readable storage medium, brake system and a vehicle.

### BACKGROUND

An electric compact wheel loader accelerates in downhill conditions, if the electric motor cannot provide a sufficient brake torque. This happens for example, if lower voltage systems are used. Consequently, on the one hand, physical limits of the transmission can be exceeded and, on the other hand, the friction brake may be overheated, which can lead to dangerous situations. This can lead in particular to failure during braking and, in the worst case, not only to fender benders or alike but also to personal damage.

### SUMMARY

An object of the disclosure is to provide a method and a control unit for controlling a speed of a vehicle depending on a determined actual driving condition of the vehicle as well as a computer program product, a non-transitory computer-readable storage medium, brake system and a vehicle to overcome the disadvantages outlined above. In particular, an object of the disclosure is to provide a method, a control unit, a computer program product, a non-transitory computer-readable storage medium, brake system and a vehicle that provides an increased braking safety.

According to a first aspect of the disclosure, the object is achieved by a method according to claim 1. The method is configured for controlling a speed of a vehicle depending on a determined actual driving condition of the vehicle.

Preferably, the vehicle is a working machine, for example a wheel loader.

Such a vehicle comprises a drive unit. The drive unit is coupled to at least one wheel of the vehicle. Preferably, the drive unit is coupled to each wheel of the vehicle. Alternatively, it may be preferred that the vehicle comprises a drive unit for each wheel. In particular, it may be preferred that the vehicle comprises at least two drive units, wherein each drive unit is coupled to at least two wheels of the vehicle. Preferably, the drive units is directly coupled to a wheel of the vehicle. However, it may also be preferred that the drive unit or the drive units are coupled to a wheel or coupled to several wheels via a gear box or alike.

The drive unit is configured for driving and braking the at least one wheel of the vehicle. In particular, by means of the drive unit, the vehicle is accelerated to a desired speed and/or driven with a desired speed. Further preferably, the vehicle is braked or deaccelerated by means of the drive unit. In the later case, the drive units is to be understood as some kind of motor brake.

Preferably, the drive unit is or comprises an electric motor. The electric motor may be a direct current drive or an asynchronous drive. Alternatively or additionally, the drive unit is or comprises a hydrostatic drive unit.

Further, the vehicle comprises a sensor unit. The sensor unit is configured for detecting an actual speed value of the vehicle. The sensor unit may detect the speed by measuring the rotational speed of one or more wheels. Additionally or alternatively, the sensor unit may detect the speed by measuring the rotational speed of the drive unit. It may also be preferred to measure the speed by means of global navigation satellite system.

In particular, the sensor unit is or comprises a speed sensor.

Preferably, the sensor unit is based on a potentiometer, an optical encoder, a hall sensor, an inductive encoder, a reed sensor or alike. Alternatively or additionally, the sensor unit may be based on a global navigation satellite system.

Further, the vehicle has some kind of brake system. The brake system is coupled to the at least one wheel of the vehicle. The brake system is configured for braking the at least one wheel of the vehicle. Thus, the brake system enables to decelerate the vehicle if needed. Preferably, the brake system is some kind of mechanical brake. In particular, the brake system is or comprises a friction brake unit. Usually, in preferred embodiments the brake system comprises a service brake and/or a parking brake. Preferably, the brake system comprises a disk brake and/or a drum brake.

Finally, the vehicle comprises a control unit. In particular, the vehicle comprises a control unit as described herein. The control unit is configured for controlling the speed of the vehicle depending on the actual driving condition of the vehicle. For this purpose, the control unit is signalling coupled with the sensor unit, the drive unit, and the brake system. It may be preferred that the control unit is signalling coupled to some or all device via a wire or wirelessly.

For controlling the speed of the vehicle depending on the actual driving condition of the vehicle, the method comprises several steps. These steps of the method will be elaborated in the following.

The method comprises the step of determining the actual speed value of the vehicle. The actual speed value of the vehicle is determined by means of the sensor unit. Further, the method comprises the step of determining a maximum speed value and determining a critical speed value. The maximum speed value and/or the critical speed value may be determined by the user and/or the manufacturer and/or the seller of the vehicle. In particular, the maximum speed value and/or the critical speed value depends on the drive unit the vehicle comprises. Preferably, the maximum speed value and/or the critical speed value depends on the performance data of the drive unit.

It is to be understood that the critical speed value is defined to be larger than the maximum speed value. Depending on the determined critical speed value and the determined maximum speed value the speed of the vehicle is controlled as will be described in the following.

According to a further step of the method, the actual driving condition is determined. Determining the driving condition depends on the determined actual speed value of the vehicle as well as the determined maximum speed value and the determined critical speed value. Accordingly, the driving condition is at least one of the following: an over speed driving condition, an acceleration driving condition or a regular driving condition. The over speed driving condition exists if the determined actual speed value is larger than the determined maximum speed value and smaller than the determined critical speed value. The acceleration driving condition exists if the vehicle is accelerated and the determined actual speed value is smaller than the determined maximum speed value. Finally, the regular driving condition exists if the vehicle is not accelerated and the determined actual speed value is smaller than the determined maximum speed value.

The method further comprises the step of determining a target speed value of the vehicle that is smaller than the determined maximum speed value. Depending on the determined a target speed value, the method further comprises following two steps if the driving condition is determined as the over speed driving condition: determining a speed braking signal value for actuating the friction braking unit depending on the determined target speed value, and providing the speed braking signal value to the brake system for actuating the friction braking unit.

If an acceleration of the machine, deviating from maximum requested speed, is being detected, the machine speed can be automatically reduced via actuation of the friction brake. By using the friction brake only for a short time, an overheating of the friction brake can be prevented. Overheating can lead to fading and can cause thermal damages.

As to further advantages, preferred embodiments and details of the method, reference is made to the corresponding aspects and embodiments of the control unit, the computer program product, the non-transitory computer-readable storage medium, the brake system and the vehicle described herein below.

According to a preferred embodiment of the method, it is provided that the method comprises further steps. In particular, the method comprises the step of determining a target braking duration value. The target braking duration value is the value a braking duration of the vehicle should last. Hereby, the target braking duration value is to be determined in such a manner that the brake system, in particular the friction brake, does not overheat. The longer a braking procedure lasts the higher the risk of degeneration of the brake system. Thus, the target braking duration value is to be determined in such a manner that the brake system does not overheat. It is to be understood that the target braking duration value may vary depending on the type of brake system. For example if the brake system comprises relatively large disk brakes, the target braking duration value may be larger in comparison to a target braking duration value of a brake system having smaller disk brakes. Further, the target braking duration value may also decrease over time if the brake system is regularly used over a longer period of time as the brake system is not able to cool down sufficiently.

Additionally or alternatively, the method comprises the step of determining a target deceleration value of the vehicle. Similarly to the target braking duration value the target deceleration value depends on the type of brake system used. If the brake system comprises relatively large disk brakes, the target deceleration value may be larger in comparison to a brake system with smaller disk brakes. Also, the target deceleration value decreases over time if the brake system is regularly used over a longer period of time as the brake system is not able to cool down sufficiently.

Further, additionally or alternatively, the method comprises the step of determining the speed braking signal value for actuating the friction braking unit depends on the determined target braking duration value and/or the determined target deceleration value.

By considering the target braking duration value and/or the determined target deceleration value it decreases the risk of overheating of the brake system. In particular, controlling and efficiency of the braking of the brake system is improved.

In a further preferred embodiment, the method comprises further steps. It is provided that the method comprises the step of determining a minimum braking resting duration of the friction braking unit between a prior first braking operation due to a prior first over speed driving event and a subsequent second braking operation due to a subsequent second over speed driving event, and determining an actual braking resting duration between the prior first braking operation due to the prior first over speed driving event and the subsequent second braking operation due to the subsequent second over speed driving event, wherein the speed braking signal value for actuating the friction braking unit is only provided for actuating the friction braking unit if the determined actual braking resting duration exceeds the determined minimum braking resting duration of the friction braking unit.

By determining the minimum braking resting duration it is assured that the brake system has sufficient time to cool down to ensure safe braking of the vehicle. Further, by tracking the actual braking resting duration time, controlling and efficiency of the braking of the brake system may be improved as braking resting duration that may be too short for cooling down or longer braking resting duration that allow to cool down the braking system more than necessary for safety reasons can be considered.

In another preferred embodiment the method comprises the step of determining a maximum braking duration value that is larger than the determined target braking duration value.

Further, to prevent degeneration and overheating of the brake system, a braking procedure of the vehicle should not exceed the maximum braking duration value. Otherwise, the brake system overheats and degenerates.

Yet in a further preferred embodiment, the method comprises the step of counting the number of braking operations due to over speed driving events.

By considering the number of braking operations due to over speed drive events, durability of the brake system can be better estimated. In particular, this allows to better control the brake system with respect to the parameters introduced above.

Further in a preferred embodiment of the method it is provided that determining the minimum braking resting duration depends on at least one of the following:
an actual weight of the vehicle,
the determined actual speed value,
the determined target speed value of the prior first braking operation,
the determined target braking duration value of the prior first braking operation,
the determined target deceleration value of the prior first braking operation,
the counted number of braking operations due to prior over speed driving events, and
the target speed value to be determined for the subsequent second braking operation.

According to another preferred embodiment of the method, determining the target speed value depends on at least one of the following:
an actual weight of the vehicle,
the determined actual speed value,
the determined target speed value of the prior first braking operation,
the determined target braking duration value of the prior first braking operation,
the determined target deceleration value of the prior first braking operation,
the counted number of braking operations due to prior over speed driving events,
the target speed value to be determined for the subsequent second braking operation, and
the time between a prior first over speed driving condition and a subsequent second over speed driving condition.

Further, in a preferred embodiment of the method the brake system comprises a service brake, in particular a friction brake, and/or a parking brake, in particular a spring applied hydraulically released brake unit. Preferably, the method comprises the step of releasing the hydraulic pressure in the spring applied hydraulically released brake unit depending on the speed braking signal value provided to the brake system, in particular below a spring braking force of the spring of the spring applied hydraulically released brake unit.

According to a further aspect of the disclosure, the object is achieved by a control unit according to claim 9. The control unit is configured for controlling a speed of a vehicle, in particular of a working machine such as a wheel loader, depending on an actual driving condition of the vehicle. Further, the control unit is configured to perform the method according to the aspect and its embodiments of the method described herein above.

As to the advantages, preferred embodiments and details of the control unit, reference is made to the corresponding aspects and embodiments of the method and/or the computer program product and/or the non-transitory computer-readable storage medium and/or the brake system and/or the vehicle described herein above and/or below.

According to a further aspect of the disclosure, the object is achieved by a computer program product according to claim 10. The computer program product comprising program code for performing, when executed by the control unit, the method according to the aspect and its embodiments of the method described herein above and/or below.

As to the advantages, preferred embodiments and details of the computer program product, reference is made to the corresponding aspects and embodiments of the method and/or the control unit and/or the non-transitory computer-readable storage medium and/or the brake system and/or the vehicle described herein above and/or below.

According to a further aspect of the disclosure, the object is achieved by a non-transitory computer-readable storage medium according to claim 11. The non-transitory computer-readable storage medium comprising instructions, which when executed by the control unit, cause the control unit to perform the method according to the aspect and its embodiments of the method described herein above.

As to the advantages, preferred embodiments and details of the non-transitory computer-readable storage medium, reference is made to the corresponding aspects and embodiments of the method and/or the control unit and/or the computer program product and/or the brake system and/or the vehicle described herein above and/or below.

According to a further aspect of the disclosure, the object is achieved by a brake system according to claim 12. The brake system is configured for braking at least one wheel of a vehicle, the brake system comprising a control unit of the aspect and its embodiments of the control unit described herein above.

As to the advantages, preferred embodiments and details of the brake system, reference is made to the corresponding aspects and embodiments of the method and/or the control unit and/or the computer program product and/or the non-transitory computer readable storage medium and/or the vehicle described herein above and/or below.

According to a further aspect of the disclosure, the object is achieved by a vehicle according to claim 13. In particular, the vehicle is a working machine such as a wheel loader.

The vehicle comprises a drive unit that is coupled to at least one wheel of the vehicle, wherein the drive unit is configured for driving and braking the at least one wheel of the vehicle, and a sensor unit that is configured for detecting actual speed value of the vehicle, and a brake system that is coupled to at least one wheel of the vehicle, wherein the brake system is configured for braking the at least one wheel of the vehicle, and a control unit according to claim # that is signalling coupled with the sensor unit, the drive unit, and the brake system, wherein the control unit is configured for controlling the speed of the vehicle depending on an actual driving condition of the vehicle, wherein the driving condition is one of the following: an over speed driving condition, in which the determined actual speed value is larger than the determined maximum speed value and smaller than the determined critical speed value, an acceleration driving condition, in which the vehicle is accelerated and the determined actual speed value is smaller than the determined maximum speed value, and a regular driving condition, in which the vehicle is not accelerated and the determined actual speed value is smaller than the determined maximum speed value.

As to the advantages, preferred embodiments and details of the vehicle, reference is made to the corresponding aspects and embodiments of the method and/or the control unit and/or the computer program product and/or the non-transitory computer readable storage medium and/or the brake system described herein above.

According to a preferred embodiment of the vehicle, the drive unit is or comprises an electric drive unit and/or is or comprises a hydrostatic drive unit. Additionally or alternatively, the brake system comprises a service brake, in particular a friction brake, and/or a parking brake, in particular a spring applied hydraulically re-leased brake unit.

In a further preferred embodiment, of the vehicle the sensor unit is or comprises at least one sensor that is configured for detecting the actual speed of the vehicle, and/or at least one sensor that is configured for detecting an actual acceleration of the vehicle, and/or at least one sensor that is configured for detecting an actual inclination of the vehicle, and/or at least one GNSS-sensor, and/or at least one sensor that is configured for detecting an actuation of a braking pedal, for example an angle sensor.

Embodiments of the disclosure are now described below with reference to the drawings. These are not necessarily intended to show the embodiments to scale; rather, where useful for explanation, the drawings are in schematized and/or slightly distorted form. With regard to additions to the gauges directly recognizable from the drawings, reference is made to the relevant prior art. It should be borne in mind that a wide variety of modifications and changes concerning the shape and detail of an embodiment can be made without departing from the general idea of the disclosure. The features of the disclosure disclosed in the description, in the drawings as well as in the claims may be essential for the further development of the disclosure both individually and in any combination. In addition, all combinations of at least two of the features disclosed in the description, the drawings and/or the claims fall within the scope of the disclosure. The general idea of the disclosure is not limited to the exact form or detail of the preferred embodiments shown and described below, or limited to any subject matter that would be limited as compared to the subject matter claimed in the claims. In the case of stated design ranges, values lying within the stated limits are also intended to be disclosed as limiting values and to be capable of being used and claimed as desired. For simplicity, identical reference signs are used below for identical or similar parts or parts with identical or similar function.

Further advantages and advantageous features of the disclosure are disclosed in the following description and in the dependent claims.

### BRIEF DESCRIPTION OF THE DRAWINGS

With reference to the appended drawings, below follows a more detailed description of embodiments of the disclosure cited as examples.

In the drawings:

FIG. 1 is a schematic side view of a wheel loader in a preferred embodiment;

FIG. 2 is schematic view a preferred embodiment of the brake system for controlling a speed of the wheel loader shown in FIG. 1 according to one of the methods illustrated in FIGS. 3 and 4

FIG. 3 is a schematic block diagram of a preferred embodiment of the method for controlling a speed of the wheel loader shown in FIG. 1 depending on a determined actual driving condition of the wheel loader; and

FIG. 4 is a schematic block diagram of a further preferred embodiment of the method for controlling a speed of the wheel loader shown in FIG. 1 depending on a determined actual driving condition of the wheel loader.

### DETAILED DESCRIPTION OF EXAMPLE EMBODIMENTS

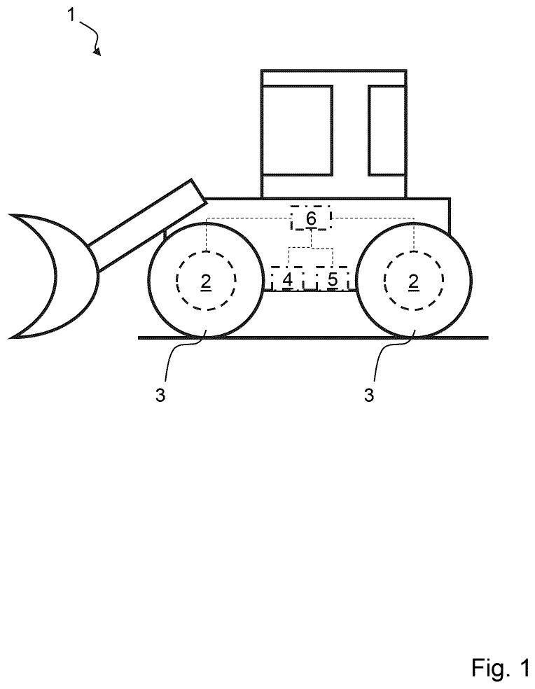

FIG. 1 is a schematic side view of a wheel loader as a vehicle 1 in a preferred embodiment.

The wheel loader 1 shown in FIG. 1 comprise four drive units 2 each of which is coupled to a single wheel 3 of the wheel loader 1. By means of the drive units 2 the wheel loader 1 is accelerated to a desired speed or run with a desired speed. Thus, the drive units 2 enable driving the wheel loader 1 by driving the respective wheels 3. Further, the drive units 2 are configured for braking the respective wheel 3 and, thus, the wheel loader 1. Thus, the drive units also enable deceleration of the wheels and, thus, the wheel loader 1. In this preferred embodiment, the drive units 2 are electric drive units. However, it is possible as well that the drive units 2 are hydrostatic drive units.

Further, for controlling the speed of the wheel loader 1 depending on an actual driving condition of the wheel loader 1, the wheel loader 1 comprises a sensor unit 4, a brake system 5 and a control unit 6.

The sensor unit 4 is configured for detecting actual speed value of the wheel loader 1. In this preferred embodiment, the sensor unit 4 comprises sensors that are configured for detecting the actual speed, for detecting an actual acceleration, and for detecting an actual inclination of the wheel loader as well as a sensor that is configured for detecting an actuation of the brake system 5.

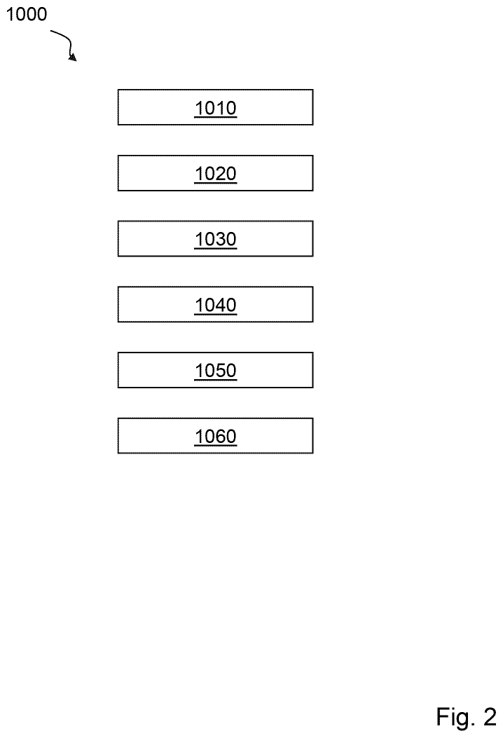

The brake system 5 is coupled to each wheel 3 of the wheel loader 1. The brake system 5 is configured for braking each wheel 3 of the vehicle. In this preferred embodiment, the brake system comprises a friction brake as service brake and a spring applied hydraulically re-leased brake unit as parking brake. This particular embodiment of the brake system 5 allows to prevent overheating in a particular preferred manner. The brake system 5 is described in detail below with respect to FIG. 2.

The control unit 6 is signalling coupled to each drive unit 2, the sensor unit 4 and the brake system 5 of the wheel loader 1. The control unit 6 is configured for controlling the speed of the wheel loader 1 depending on an actual driving condition of the wheel loader 1. Thereby, the actual driving condition of the wheel loader 1 is one of the following:
an over speed driving condition, in which the determined actual speed value is larger than the determined maximum speed value and smaller than the determined critical speed value,
an acceleration driving condition, in which the wheel loader 1 is accelerated and the determined actual speed value is smaller than the determined maximum speed value, and
a regular driving condition, in which the wheel loader 1 is not accelerated and the determined actual speed value is smaller than the determined maximum speed value.

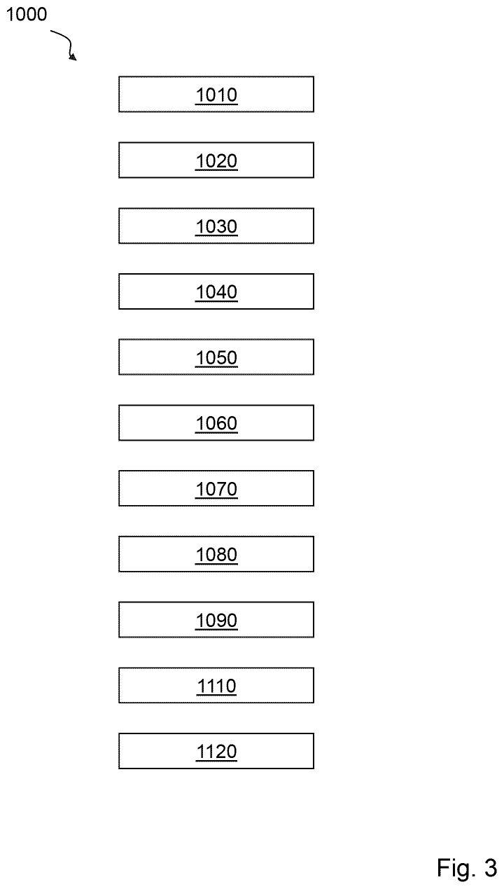

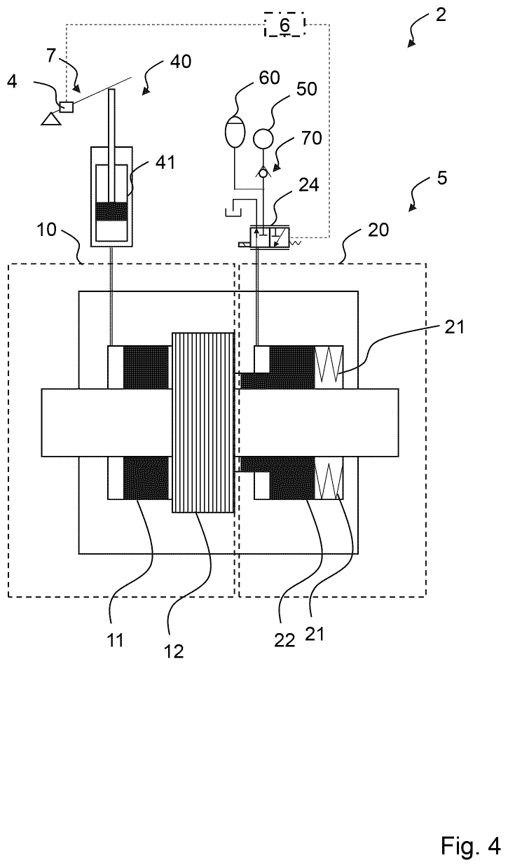

FIG. 2 is schematic view of a preferred embodiment of the brake system 5 for controlling the speed of the wheel loader 1 shown in FIG. 1 according to one of the embodiments of the method schematically illustrated as block diagrams in FIGS. 3 and 4.

The brake system 5 comprises a hydraulically actuated service brake 10. The service brake 10 is configured for braking the wheel loader 1. For this purpose, the service brake 10 comprises a service brake cylinder 11 and a disk pack unit 12. The service brake cylinder 11 is configured to transfer a service braking force to the disk pack unit 12 while braking the wheel loader 1. The disk pack unit 12 is configured for braking the wheel loader 1 depending on the braking force.

Furthermore, the brake system 5 comprises a hydraulically actuated parking brake 20. The parking brake 20 is a spring applied hydraulic release brake. The spring applied hydraulic release brake is configured for braking the wheel loader 1 depending on a parking brake force. For this purpose, the parking brake 20 comprises a spring braking unit 21, a hydraulic park braking control unit 23, and a parking brake cylinder 22.

The spring braking unit 21 is configured to generate a default parking brake force and to transfer the default parking brake force onto a parking brake cylinder 22. The control unit 6 is configured to generate a release force and to transfer the release force onto the parking brake cylinder 22 in order to control the parking brake force. Finally, the parking brake cylinder 22 is in mechanical contact with the disk pack unit 12. Thereby, the parking brake cylinder 22 is configured to transfer the parking braking force to the disk pack unit 12 while braking depending on the control parking brake force and the default parking brake force.

The control unit 6 is signalling coupled to a control valve 24. The control valve 24 is hydraulically connected to the parking brake 20 and configured for controlling a hydraulic pressure inside of the parking brake 20. The hydraulic pressure inside of the parking brake 20 is controlled depending on a braking signal for hydraulically actuating and/or releasing the parking brake 20. In this preferred embodiment, the control valve 24 is a proportional 3/2 directional valve with a spring reset. The control valve 24 controls the hydraulic flow into the parking brake 20 for releasing the parking brake 20 and out of the parking brake 20 for braking the parking brake 20 depending on the braking signal detected by a sensor unit 4. The sensor unit 4 is adapted for detecting the braking signal for braking the wheel loader 1. Hereto, the sensor unit 4 may comprise different kind of sensors that are adapted to detect a respective braking signal. For example, the sensor unit may comprise an angle sensor, a position sensor, and/or a hydraulic pressure sensor. In this preferred embodiment, the sensor unit 4 comprises an angle sensor that is configured for detecting an angle of a braking pedal 7.

For controlling the braking of the wheel loader 1, the service brake 10 comprises a hydraulic service braking control unit 40 that is configured to generate the service braking force and to transfer the service braking force to the service brake cylinder 11. In this preferred embodiment, the hydraulic service braking control unit 40 comprises a master brake cylinder 41 that is hydraulically connected to the service brake cylinder 11 for generating the service braking force. It is to be understood that the parking brake 20 is actuated depending on an opening pressure and the service brake 10 is actuated depending on an actuation pressure.

FIGS. 3 and 4 are schematic block diagrams of preferred embodiments of the method 1000 for controlling a speed of the wheel loader 1 shown in FIG. 1 depending on a determined actual driving condition of the wheel loader. Preferably, the steps of both embodiments are performed in the order as described in the following. It may be preferred that some or all of the steps are executed in parallel if possible. Additional or alternative preferred embodiments of the method 1000 may execute some or all of the steps in an order that is different to the order as described herein below.

In FIG. 3, the method 1000 comprises six steps 1010, 1020, 1030, 1040, 1050, 1060.

A first step of the method 1000 relates to determining 1010 the actual speed value of the wheel loader 1 provided by means of the sensor unit 4.

Subsequently, the method comprises the steps of determining 1020 a maximum speed value and determining a critical speed value, wherein the critical speed value is larger than the maximum speed value, and determining 1030 the actual driving condition of the wheel loader 1. Thereby, the driving condition is at least one of the following: an over speed driving condition, an acceleration driving condition, and a regular driving condition. The driving condition is considered as over speed driving condition if the determined actual speed value is larger than the determined maximum speed value and smaller than the determined critical speed value. The acceleration driving condition is considered as driving condition if the wheel loader 1 is accelerated and the determined actual speed value is smaller than the determined maximum speed value. Finally, the regular driving condition is considered as driving condition if the wheel loader 1 is not accelerated and the determined actual speed value is smaller than the determined maximum speed value.

Next, the method comprises the step of determining 1040 a target speed value of the wheel loader 1 that is smaller than the determined maximum speed value. Determining 1040 the target speed value depends on at least one of the following:
an actual weight of the wheel loader 1,
the determined actual speed value,
the determined target speed value of the prior first braking operation,
the determined target braking duration value of the prior first braking operation,
the determined target deceleration value of the prior first braking operation,
the counted number of braking operations due to prior over speed driving events,
the target speed value to be determined for the subsequent second braking operation, and
the time between a prior first over speed driving condition and a subsequent second over speed driving condition.

Finally, the method 1000 comprises the steps of determining 1050 a speed braking signal value for actuating the friction braking unit depending on the determined target speed value, and of providing 1060 the speed braking signal value to the brake system 5 for actuating the friction braking unit if the driving condition is determined as the over speed driving condition.

The preferred embodiment of the method 1000 schematically depicted as block diagram in FIG. 4 is based on the method described with respect to FIG. 3. The embodiment referred to in FIG. 4 comprises five additional steps in comparison to the embodiment described herein above with respect to FIG. 4.

The method 1000 comprises the steps of determining 1070 a target braking duration value, and determining 1080 a target deceleration value of the wheel loader. It is to be understood that the step of determining 1050 a speed braking signal value for actuating the friction braking unit additionally depends on determined target braking duration value and the determined target deceleration value.

Further, the method 1000 comprises the steps of determining 1090 a minimum braking resting duration of the friction braking unit between a prior first braking operation due to a prior first over speed driving event and a subsequent second braking operation due to a subsequent second over speed driving event, and determining 1100 an actual braking resting duration between the prior first braking operation due to the prior first over speed driving event and the subsequent second braking operation due to the subsequent second over speed driving event. Thereby, the speed braking signal value for actuating the friction braking unit is only provided for actuating the friction braking unit if the determined actual braking resting duration exceeds the determined minimum braking resting duration of the friction braking unit.

Finally, the method 1000 comprises the steps of determining 1110 a maximum braking duration value that is larger than the determined target braking duration value and counting 1120 the number of braking operations due to over speed driving events.

It is to be understood that determining 1090 the minimum braking resting duration depends on at least one of the following:
an actual weight of the wheel loader 1,
the determined actual speed value,
the determined target speed value of the prior first braking operation,
the determined target braking duration value of the prior first braking operation,
the determined target deceleration value of the prior first braking operation,
the counted number of braking operations due to prior over speed driving events, and
the target speed value to be determined for the subsequent second braking operation.

In case the brake system 5 comprises a friction brake as service brake and a spring applied hydraulically released brake unit as parking brake, it is to be understood that the method comprises the step of releasing the hydraulic pressure in the spring applied hydraulically released brake unit depending on the speed braking signal value provided to the brake system 5, in particular below a spring braking force of the spring of the spring applied hydraulically released brake unit.

### REFERENCE SIGNS

1 vehicle
2 drive unit
3 wheel
4 sensor unit
5 brake system
6 control unit
7 braking pedal
10 service brake
11 service brake cylinder
12 disk pack unit
20 parking brake
21 spring braking unit
22 parking brake cylinder
24 control valve
41 master brake cylinder
50 hydraulic pump
60 hydraulic accumulator
70 check valve

1. A method for controlling a speed of a vehicle depending on a determined actual driving condition of the vehicle,
the vehicle comprising:
a drive unit that is coupled to at least one wheel of the vehicle, wherein the drive unit is configured for driving and braking the at least one wheel of the vehicle, wherein the drive unit is configured for braking by providing a motor braking torque, and
a sensor unit that is configured for detecting an actual speed value of the vehicle, and
a brake system that is coupled to at least one wheel of the vehicle, wherein the brake system is configured for braking the at least one wheel of the vehicle, and
a control unit that is signalling coupled with the sensor unit, the drive unit, and the brake system, wherein the control unit is configured for controlling the speed of the vehicle,
the method comprising:
determining the actual speed value of the vehicle provided by means of the sensor unit, and
determining a maximum speed value and determining a critical speed value,
wherein the critical speed value is larger than the maximum speed value, and
determining the actual driving condition of the vehicle, wherein the driving condition is at least one of the following:
an over speed driving condition if the determined actual speed value is larger than the determined maximum speed value and smaller than the determined critical speed value,
an acceleration driving condition if the vehicle is accelerated and the determined actual speed value is smaller than the determined maximum speed value,
a regular driving condition if the vehicle is not accelerated and the determined actual speed value is smaller than the determined maximum speed value,
determining a target speed value of the vehicle that is smaller than the determined maximum speed value, and
wherein if the driving condition is determined as the over speed driving condition,
the method comprising the steps of
determining a speed braking signal value for actuating the friction braking unit depending on the determined target speed value, and
providing the speed braking signal value to the brake system for actuating the friction braking unit.

2. The method according to claim 1, further comprising:
determining a target braking duration value, and/or
determining a target deceleration value of the vehicle, and/or
determining the speed braking signal value for actuating the friction braking unit depends on the determined target braking duration value and/or the determined target deceleration value.

3. The method according to claim 1, comprising:
determining a minimum braking resting duration of the friction braking unit between a prior first braking operation due to a prior first over speed driving event and a subsequent second braking operation due to a subsequent second over speed driving event, and
determining an actual braking resting duration between the prior first braking operation due to the prior first over speed driving event and the subsequent second braking operation due to the subsequent second over speed driving event, wherein the speed braking signal value for actuating the friction braking unit is only provided for actuating the friction braking unit if the determined actual braking resting duration exceeds the determined minimum braking resting duration of the friction braking unit.

4. The method according to claim 1, comprising:
determining a maximum braking duration value that is larger than the determined target braking duration value.

5. The method according to claim 1, comprising:
counting the number of braking operations due to over speed driving events.

6. The method according to claim 1, wherein determining the minimum braking resting duration depends on at least one of the following:
an actual weight of the vehicle,
the determined actual speed value,
the determined target speed value of the prior first braking operation,
the determined target braking duration value of the prior first braking operation,
the determined target deceleration value of the prior first braking operation,
the counted number of braking operations due to prior over speed driving events, and
the target speed value to be determined for the subsequent second braking operation.

7. The method according to claim 1, wherein determining the target speed value depends on at least one of the following:
an actual weight of the vehicle,
the determined actual speed value,
the determined target speed value of the prior first braking operation,
the determined target braking duration value of the prior first braking operation,
the determined target deceleration value of the prior first braking operation,
the counted number of braking operations due to prior over speed driving events,
the target speed value to be determined for the subsequent second braking operation, and
the time between a prior first over speed driving condition and a subsequent second over speed driving condition.

8. The method according to claim 1,
wherein the brake system comprises a service brake,
the method comprising releasing the hydraulic pressure in the spring applied hydraulically released brake unit depending on the speed braking signal value provided to the brake system, in particular below a spring braking force of the spring of the spring applied hydraulically released brake unit.

9. A control unit for controlling a speed of a vehicle depending on an actual driving condition of the vehicle, wherein the control unit is configured to perform the method of claim 1.

10. A computer program product comprising program code for performing, when executed by the control unit, the method of claim 1.

11. A non-transitory computer-readable storage medium comprising instructions, which when executed by the control unit, cause the control unit to perform the method of claim 1.

12. A brake system for braking at least one wheel of a vehicle, the brake system comprising a control unit according to claim 9.

13. A vehicle comprising:
a drive unit that is coupled to at least one wheel of the vehicle, wherein the drive unit is configured for driving and braking the at least one wheel of the vehicle, and
a sensor unit that is configured for detecting actual speed value of the vehicle, and
a brake system that is coupled to at least one wheel of the vehicle, wherein the brake system is configured for braking the at least one wheel of the vehicle, and
a control unit according to claim 9 that is signalling coupled with the sensor unit,
the drive unit, and the brake system, wherein the control unit is configured for controlling the speed of the vehicle depending on an actual driving condition of the vehicle, wherein the driving condition is one of the following:
an over speed driving condition, in which the determined actual speed value is larger than the determined maximum speed value and smaller than the determined critical speed value,
an acceleration driving condition, in which the vehicle is accelerated and the determined actual speed value is smaller than the determined maximum speed value, and
a regular driving condition, in which the vehicle is not accelerated and the determined actual speed value is smaller than the determined maximum speed value.

14. The vehicle according to claim 13,
wherein the drive unit comprises an electric drive unit and/or comprises a hydrostatic drive unit, and/or
wherein the brake system comprises a service brake, in particular a friction brake, and/or a parking brake, in particular a spring applied hydraulically re-leased brake unit.

15. The vehicle according to claim 13, wherein the sensor unit comprises
at least one sensor that is configured for detecting the actual speed of the vehicle, and/or
at least one sensor that is configured for detecting an actual acceleration of the vehicle, and/or
at least one sensor that is configured for detecting an actual inclination of the vehicle, and/or
at least one GNSS-sensor, and/or
at least one sensor that is configured for detecting an actuation of a braking pedal, for example an angle sensor.
